(19) United States
(12) Patent Application Publication
(10) Pub. No.: US 2014/0368313 A1
(43) Pub. Date: Dec. 18, 2014

(54) VEHICLE KEYFOB WITH ACCELEROMETER TO EXTEND BATTERY LIFE

(71) Applicant: TEXAS INSTRUMENTS INCORPORATED, Dallas, TX (US)

(72) Inventor: Klaus Seiberts, Sugar Land, TX (US)

(21) Appl. No.: 13/917,826

(22) Filed: Jun. 14, 2013

(51) Int. Cl. G07C 9/00

(52) U.S. Cl. CPC G07C 9/00111
USPC 340/5.61

(57) ABSTRACT

A keyfob is disclosed for use with a vehicle. The keyfob includes a microcontroller, a wake receiver, an antenna coupled to the wake receiver, and an accelerometer. The accelerometer is used to detect motion of the keyfob. The microcontroller disables the wake receiver based on signals from the accelerometer (e.g., when the keyfob is determined to be stationary and not close to the vehicle).

### CROSS-REFERENCE TO RELATED APPLICATION

N/A.

### BACKGROUND

Automotive keyless entry systems first were introduced as a numeric keypad located on the exterior door panel of a vehicle. Such keyless entry systems have evolved to passive entry/passive start (PEPS) systems.

A PEPS system uses a remote handheld transceiver, which is commonly referred to as a “fob” (or “keyfob”), to provide a communication channel between the keyfob and a control unit installed in a vehicle. In such a PEPS system, an operator carrying the keyfob need not push a button on the keyfob to execute certain functions such as locking/unlocking the vehicle's doors and starting the engine of the vehicle. More specifically, the keyfob is designed to unlock the vehicle's doors as the operator with the keyfob approaches the vehicle within a certain predefined range of the vehicle.

In current technology of PEPS systems, a commonly used mechanism is that the vehicle transmits a low-frequency (LF) signal, which is received by a wake receiver in the keyfob. Based on the received LF signal, an ultra-high-frequency (UHF) signal is generated from the keyfob and transmitted back to the vehicle in order for the vehicle to verify that the keyfob is legitimate.

### SUMMARY

Typically, a wireless keyfob operable with a vehicle comprises a wake receiver to receive a wireless communication signal from the vehicle. This wake receiver is generally operational 100% of the time to assure the keyfob is ready to operate the vehicle. However, the keyfob usually may sit idle and out of vehicle's wireless communication range for a large percentage of the time, which means that the keyfob's wake receiver is on and operational but is not being used to operate the vehicle. Thus, maintaining the keyfob's wake receiver in an “on” state shortens the keyfob's battery lifetime. An operator of the vehicle needs to replace the battery more frequently. Replacing the battery is an inconvenience to the operator of the vehicle.

In accordance with various embodiments, a keyfob with an integrated accelerometer for use with a vehicle and a method used therein are disclosed. The keyfob comprises a microcontroller, a wake receiver, an antenna coupled to the wake receiver and an integrated accelerometer to detect motion of the keyfob, in which the microcontroller disables the wake receiver based on a signal from the integrated accelerometer. The integrated accelerometer is polled by the microcontroller to determine whether the keyfob is moving or stationary while the keyfob is outside any wireless communication range ascertained by transceivers installed in the vehicle. By disabling the wake receiver based on signals from the accelerometer, a battery's lifetime included in the keyfob is extended.

A disclosed method to operate the disclosed keyfob comprises determining whether the keyfob has received the signal from the vehicle (e.g., within the wireless communication range); if the keyfob has not received the signal from the vehicle, the accelerometer is polled by the microcontroller to determine whether the keyfob is moving or stationary based on the signal from the accelerometer. Upon determining that the keyfob is stationary, the microcontroller disables the wake receiver to keep scanning any wireless signals from the vehicle.

### BRIEF DESCRIPTION OF THE DRAWINGS

For a detailed description of exemplary embodiments of the invention, reference will now be made to the accompanying drawings in which:

FIG. 1 illustrates a keyfob for use with a vehicle in accordance with the disclosed principles;

FIG. 2 shows a block diagram of an illustrative keyfob in accordance with the disclosed principles;

FIG. 3 illustrates various locations in which a keyfob is and is not within wireless range of the vehicle in accordance with the disclosed principles; and

FIG. 4 shows a method in accordance with the disclosed principles.

FIG. 5 depicts an alternative method in accordance with the disclosed principles.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

As used herein, the term “vehicle” includes any type of vehicle that drives of roadways such as automobiles, trucks, and busses, as well as boats, jet skis, snowmobiles, and other types of transportation machines that are operable with a wireless keyfob.

As used herein, the term “transceiver” includes any type of wireless communication units such as transmitters, receivers, or a combination of a transmitter and a receiver.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

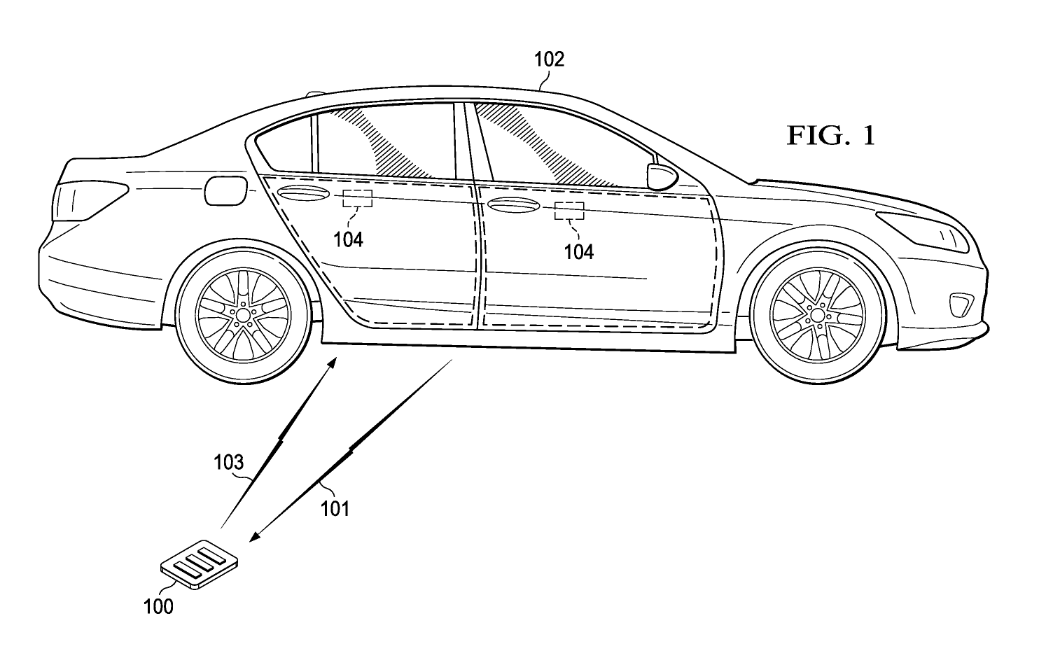

Referring to FIG. 1, a diagrammatic view illustrates a PEPS system for use with a vehicle. As depicted, the PEPS system includes a plurality of wireless transceivers 104 installed at various locations around the vehicle 102 (e.g., inside each door near the door handles, in the trunk, etc.). A PEPS keyfob 100 can be carried by an operator of the vehicle, for example, to lock and unlock a door or the trunk and to start the vehicle. The keyfob 100 performs wireless communication with whichever wireless transceivers 104 the keyfob is in range of. The PEPS keyfob 100 authenticates itself to the vehicle in order for the vehicle to provide the desired functionality (e.g., door locking or unlocking or engine starting).

Each transceiver 104 is able to transmit a low frequency (LF) signal 101 which will be received by the keyfob 100 if the keyfob is within wireless range of the vehicle's transceiver. In some implementations, upon receiving the LF signal 101, the keyfob transmits an ultra-high frequency (UHF) 103 which is received by at least one of the transceivers 104. The frequency band of the LF signals may be between 100 kHz and 150 kHz and the UHF band may be between 300 MHz and 1 GHz. The frequencies of signals 101 and 103 may be varied as desired.

The wireless receiver in typical keyfobs are on and operational generally 100% of the time in order to be ready for use in operating the vehicle. Often, however, the keyfob sits idle without being used to operate the vehicle. For example, the operator of the vehicle returns home after work and may place the keyfob on a countertop where the keyfob sits for numerous hours until the operator leaves for work the next morning. As such, for a large percentage of the time, the keyfob's receiver is on and operational but is not being used to operate the vehicle. Maintaining the keyfob's receiver in an on state causes the keyfob's battery to drain. Eventually, the battery must be replaced. Replacing the battery is an inconvenience to the operator of the vehicle.

Embodiments of the invention are directed to a keyfob with an integrated accelerometer (and corresponding method) for a passive entry/passive start (PEPS) system. The keyfob uses the accelerometer to determine when the keyfob is not moving (e.g., placed on a table). When the keyfob detects a lack of movement, an internal wake receiver is disabled to thereby extend the life of keyfob's battery. Any movement of the keyfob is detected by the accelerometer which thereby causes the receiver to be enabled.

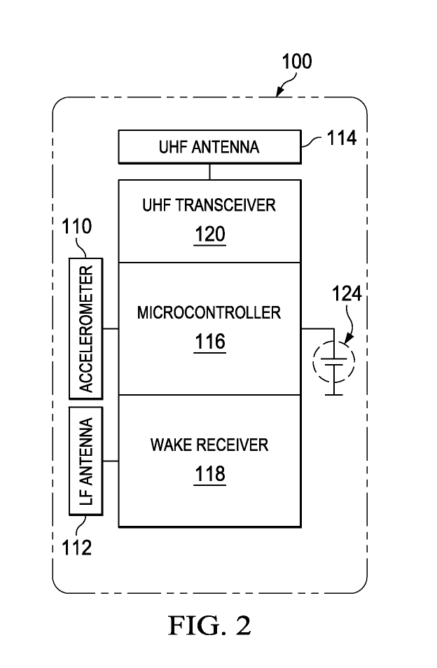

FIG. 2 shows an illustrative block diagram of PEPS keyfob 100. As shown, the keyfob includes an accelerometer 110, one or more LF antennas 112, one or more UHF antennas 114, a microcontroller 116, a wake receiver 118, and a battery 124. In the preferred embodiment shown, the integrated accelerometer 110 is used to detect motion of the keyfob 100. Microcontroller 116 controls the overall operation of the keyfob 100. The microcontroller 116 implements multiple power states such as a lower power state and a higher power state. In the higher power state, the microcontroller is fully operational. In the lower power state, the microcontroller is generally incapable of executing instructions but can be woken up by way of, for example, an interrupt. The wake receiver 118 receives signals (if any) from the LF antenna 112 (e.g., from the vehicle's wireless transceivers 104) and, if the microcontroller 116 is in a lower power state, asserts an interrupt signal to awaken the microcontroller based on receipt of LF signals and causes the microcontroller to transition to the higher power mode. The UHF antenna 114 is used to transmit UHF signals to the vehicle's wireless transceivers 104. Battery 124 provides power to the respective components of the keyfob 100.

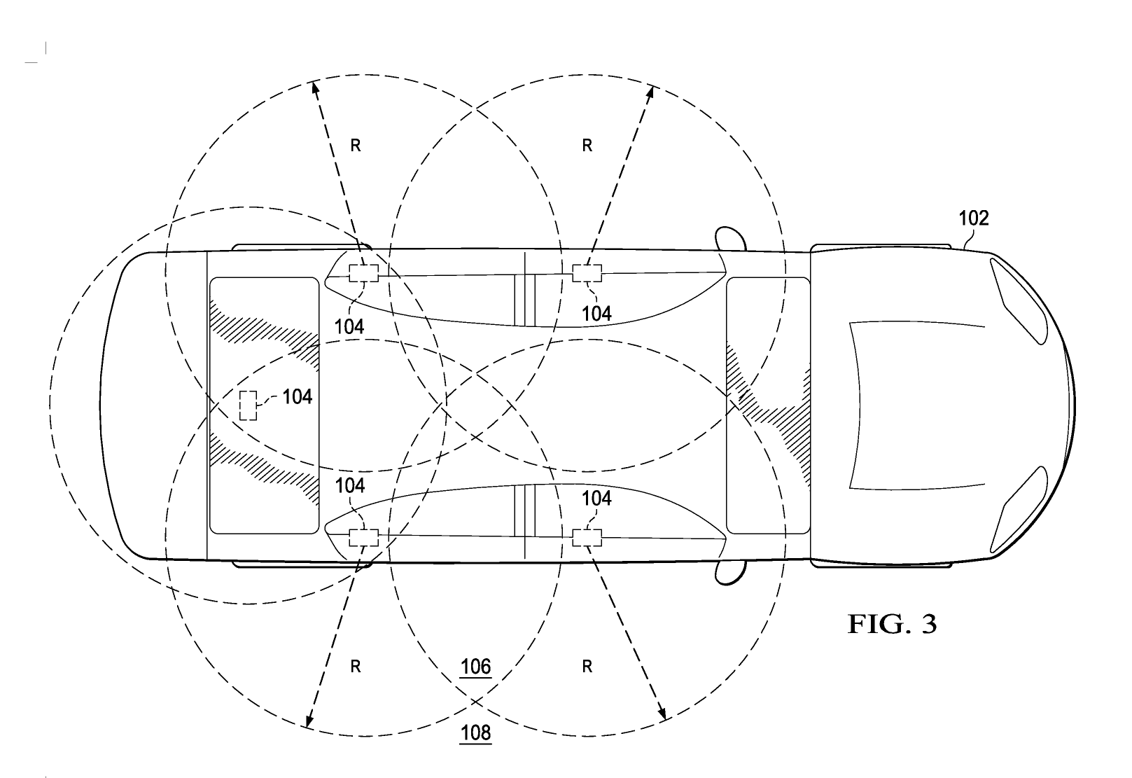

FIG. 3 illustrates a top view of vehicle 102. The dashed circles around each wireless transceiver 104 indicate the LF communication range of each of the vehicle's transceivers. For example, in FIG. 3, there are five transceivers 104 installed in the vehicle's front doors, rear doors and trunk, respectively. Each transceiver 104 has a predefined wireless range with a radius R as shown. The wireless range of neighboring transceivers may overlap as indicated by overlapping dashed circles.

Still referring to FIG. 3, the keyfob 100 preferably switches between multiple (e.g., two) states depending on whether the keyfob is within wireless range of any of the vehicle's transceivers 104 and whether the keyfob is stationary or moving. Two locations 106 and 108 are illustrated for a keyfob in FIG. 3. Location 106 is within the wireless range of at least one of the vehicle's wireless transceivers 104. Location 108 is outside of the wireless range of all the vehicle's transceivers 104. The operation of the keyfob at each location will be explained below.

For location 106, the keyfob is within wireless range of at least one of the vehicle's transceivers 104. The keyfob's wake receiver 118 is enabled and is able to receive LF signals 101 from the vehicle. The microcontroller 116 may be in its low power mode of operation but woken up by the wake receiver 118 if the receiver receives an LF signal 101 from the vehicle. The microcontroller 116 responds to the received LF signal by, for example, causing the RF antenna to transmit a RF signal 103 back to vehicle as described above.

For location 108, the keyfob 100 is outside the range of the LF wireless communication of vehicle's transceivers 104. At location 108, the wake receiver 118 will not receive LF signals from the vehicle. Once the microcontroller 116 determines that no LF signals are being received by the wake receiver 118 for a certain period of time, the microcontroller 116 transitions to the lower power state. With the microcontroller 116 in the lower power state, if movement is detected by the accelerometer 110, the accelerometer asserts an interrupt to the microcontroller 116 to awaken the microcontroller to the higher power state. The accelerometer 110 may periodically check for motion of the keyfob 100 in any suitable time interval (e.g., once every second).

If the keyfob 100 is stationary and not within wireless range of the vehicle's wireless transceivers 104, then there is no reason to maintain the wake receiver 118 in an enabled state. Thus, the microcontroller 116 causes the wake receiver 118 to be disabled thereby saving battery power.

While the wake receiver 118 is disabled, the wake receiver is not able to receive wireless signals from the vehicle. While the receiver 118 is disabled, the microcontroller 116 transitions to its lower power mode but transitions back to the higher power mode by the interrupt if the accelerometer detects motion of the keyfob. With the receiver 118 disabled and the microcontroller 116 in the lower power state, the accelerometer 110 may detect a presence of motion of the keyfob once every k seconds. In one example, k is 1 second meaning that the accelerometer 110 will sense any motion of the keyfob once every second when the receiver 118 is disabled and the microcontroller is in the lower power state. The interrupt can be programmed for the accelerometer to wake up the microcontroller at a defined rate. The time interval can be oftener than once per second.

Still referring to location 108 in FIG. 3, if the microcontroller 116 is awakened by the accelerometer 110 based on detected movement of the keyfob, then the microcontroller 116 causes the wake receiver 118 to be enabled. Because the keyfob is moving, it is possible that the operator of the vehicle is approaching the vehicle. With the wake receiver 118 enabled, the keyfob 100 can receive and react to LF signals 101 received from the vehicle's transceivers 104. For example, if the vehicle has door lock/unlock buttons on the doors, a user pressing such a button causes the vehicle to transmit the LF signal 101.

Once, however, the microcontroller 116 detects movement and enables the wake receiver 118, and if the keyfob is moved to location 106 within wireless range of vehicle's transceivers 104, the wake receiver 118 will remain enabled as long as the keyfob remains in range of transceivers 104 and continues to receive LF signals 101. In at least some embodiments, the microcontroller 116 does not communicate with the accelerometer 110 when the keyfob is in a location 106 near the vehicle because acceleration data is not of interest in this condition.

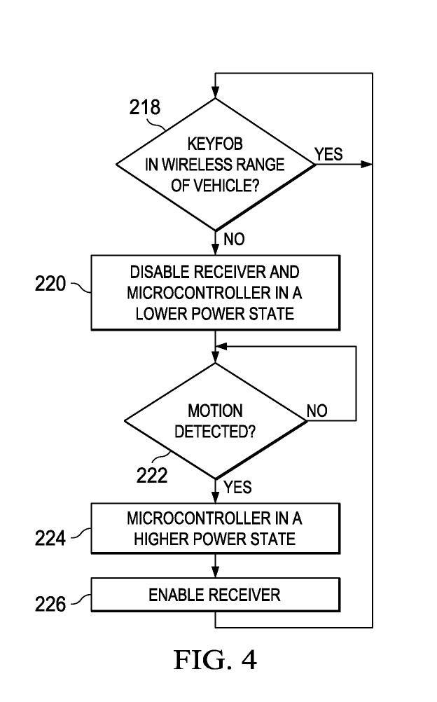

FIG. 4 shows an example of a method performed by the keyfob 100. The operations shown in FIG. 4 may be performed in the order shown or in a different order as desired. Further, two or more of the operations may be performed in parallel instead of serially.

At 218, the microcontroller 116 determines whether the keyfob 100 is located within wireless range of any of the vehicle's wireless transceivers 104 (e.g., location 106 in FIG. 3). This operation may be performed by the microcontroller 116 determining whether the wake receiver 118 has recently (e.g., in the last 10 seconds) received any LF signals 101 from the vehicle). If the microcontroller 116 determines the keyfob 100 is within wireless range of the vehicle, control loops back to operation 218 (i.e., the microcontroller continues to assess whether the keyfob is near the vehicle).

However, if the microcontroller 116 determines that the keyfob is not within wireless range of the vehicle (e.g., no LF signals received in last 10 seconds), then at 220 the microcontroller 116 disables the receiver 118 and transitions the microcontroller 116 to the lower power state, thereby further reducing the power consumption of the battery 124. If no motion of the keyfob 100 is detected by the accelerometer 110 at 222, control loops back to 222 to have the accelerometer 110 continue to detect any motion of the keyfob 100. If, however, the accelerometer 110 detects the motion based on movement of the keyfob 100, at 224 the accelerometer 110 awakens the microcontroller 116 to a higher power state via the interrupt and at 226 the microcontroller 116 enables the wake receiver 118. Once the wake receiver 118 is enabled at 226, control loops back to operation 218.

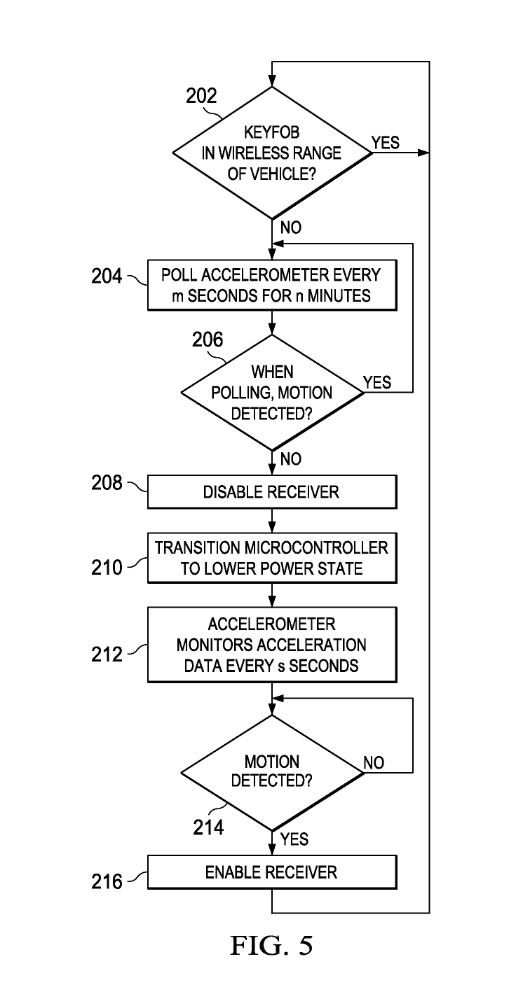

FIG. 5 shows an alternative example of a method performed by the keyfob 100. The operations shown in FIG. 5 may be performed in the order shown or in a different order as desired. Further, two or more of the operations may be performed in parallel instead of serially.

Similar to 218 in FIG. 4, at 202 the microcontroller 116 determines whether the keyfob is located within wireless range of any of the vehicle's wireless transceivers 104. This operation may be performed by the microcontroller determining whether the wake receiver 118 has recently (e.g., in the last 10 seconds) received any LF signals 101 from the vehicle). If the microcontroller 116 determines the keyfob 100 is within wireless range of the vehicle, control loops back to operation 202 (i.e., the microcontroller continues to assess whether the keyfob is near the vehicle).

However, if the microcontroller 116 determines that the keyfob is not within wireless range of the vehicle (e.g., no LF signals received in last 10 seconds), then at 204 the microcontroller 116 starts polling the accelerometer 110 every m seconds (e.g., 10 seconds) for n minutes (e.g., 5 minutes) to determine whether the keyfob 100 is moving or stationary based on a signal from the accelerometer 110 integrated in the keyfob. If motion of the keyfob 100 is detected at 206, control loops back to 204 and the n-minute polling period starts again. If, however, at 206 the keyfob has been determined to be stationary based on the signal from the accelerometer 110, the microcontroller 116 disables the wake receiver 118 at 208 to reduce power consumption. At 210, the microcontroller 116 also transitions into its low power state, thereby further reducing the power consumption of the battery 124.

At 212 (and with the wake receiver disabled), the microcontroller 116 periodically wakes up to poll the accelerometer 110. This polling interval as explained above is every s seconds (e.g., once per second). Each time the accelerometer 118 is polled by the microcontroller 116, if the microcontroller 116 determines that the keyfob 100 continues to be stationary, the polling of the accelerometer at 212 continues. However, if keyfob movement is detected, the microcontroller 116 enables the wake receiver 118 at operation 216. Then the control loops back to operation 202 (i.e., the microcontroller continues to assess whether the keyfob is near the vehicle).

The above discussion is meant to be illustrative of the principles and various embodiments of the present invention. Numerous variations and modifications will become apparent to those skilled in the art once the above disclosure is fully appreciated.

It is intended that the following claims be interpreted to embrace all such variations and modifications.

What is claimed is:

1. A keyfob for use with a vehicle, comprising:
a microcontroller;
a wake receiver;
an antenna coupled to the wake receiver; and
an accelerometer to detect motion of the keyfob;
wherein the microcontroller disables the wake receiver based on signals from the accelerometer.

2. The keyfob of claim 1 wherein the microcontroller transitions to a lower power mode of operation based on a signal from the accelerometer being indicative of lack of motion of the keyfob.

3. The keyfob of claim 2 wherein the microcontroller transitions to a higher power mode of operation based on a signal from the accelerometer being indicative of motion of the keyfob.

4. The keyfob of claim 3 wherein the microcontroller, after transitioning to the higher power mode of operation, enables the wake receiver to receive a signal from the vehicle.

5. The keyfob of claim 1 wherein the microcontroller is configured to disable the wake receiver based on:
lack of detection of a wireless signal from the vehicle; and
lack of motion of the keyfob being detected based on polling the accelerometer every m seconds for n minutes.

6. The keyfob of claim 5 wherein, after disabling the wake receiver, the microcontroller is configured to poll the accelerometer every s seconds to determine whether the keyfob is stationary or moving.

7. The keyfob of claim 6 wherein the microcontroller is configured to enable the wake receiver upon receipt of a signal from the accelerometer indicative of motion of the keyfob.

8. An apparatus in a keyfob, comprising:
a microcontroller;
a wake receiver;
an antenna coupled to the wake receiver; and
an accelerometer to detect motion of the keyfob;
wherein, based on a signal from the accelerometer, the microcontroller enables the wake receiver from a disabled state to receive a signal from a vehicle.

9. The apparatus of claim 8 wherein the microcontroller transitions from a lower power mode to a higher power mode based on a signal from the accelerometer being indicative of motion of the apparatus.

10. The apparatus of claim 8 wherein the microcontroller is configured to transition the wake receiver to the disabled state based on:
lack of detection of a wireless signal from a vehicle; and
lack of motion of the keyfob being detected based on polling the accelerometer every m seconds for n minutes.

11. The apparatus of claim 10 wherein, after disabling the wake receiver, the microcontroller is configured to poll the accelerometer every s seconds to determine whether the keyfob is stationary or moving.

12. A method, comprising:
determining whether a keyfob has received a signal from a vehicle;
if the keyfob has not received the signal from the vehicle, determining whether the keyfob is moving or stationary based on a signal from an accelerometer included in the keyfob; and
disabling a wireless receiver in the keyfob upon determining that the keyfob is stationary.

13. The method of claim 12, further comprising transitioning a microcontroller to a lower power mode upon determining that the keyfob is stationary.

14. The method of claim 12, further comprising, while the wireless receiver is disabled, the accelerometer in the keyfob ascertains an interruption signal to transition the microcontroller to a higher power mode upon determining that the keyfob is moving.

15. The method of claim 14 further comprising enabling the wireless receiver upon determining that the keyfob is moving.

17. The method of claim 12 wherein determining whether the keyfob is moving or stationary comprises polling the accelerometer at a first polling interval.

18. The method of claim 17 further comprising polling the accelerometer at a second polling interval after disabling the wireless receiver.
